(19) United States
(12) Patent Application Publication
(10) Pub. No.: US 2003/0070098 A1
(43) Pub. Date: Apr. 10, 2003

(54) Processing machine, method of administering processing machine, program and system

(75) Inventor: Shinobu Tokita, Kawasaki (JP)

Correspondence Address: STAAS & HALSEY LLP, 700 11TH STREET, NW, SUITE 500, WASHINGTON, DC, 20001, US

(73) Assignee: Fujitsu Limited Kawasaki, Japan

(21) Appl. No.: 09/970,799

(22) Filed: Oct. 5, 2001

(30) Foreign Application Priority Data
Oct. 5, 2001 (JP) 2001-140528

(51) Int. Cl. H04L 9/32

(52) U.S. Cl. 713/202; 713/1

(57) ABSTRACT

A technology of providing a function of increasing a frequency of changing authentication information when starting up a machine irrespective of whether a user is aware of it, is disclosed. A processing machine having an operating state and a stopping state comprises a control unit (2, 8) making a request for inputting the predetermined authentication information at a transition from the stopping state to the operating state, and restraining this transition if the authentication information is not inputted, and an authentication setting unit (2, 8) confirming an intention for executing a process of changing the authentication information when executing a predetermined process.

### BACKGROUND OF THE INVENTION

The present invention relates to a security function for a machine and a system.

A typical personal computer implements a password check function capable of restricting a boot of the OS by use of a password.

According to password check in the conventional machine, the password is set and changed based on a BIOS (Basic Input/Output System) setup. In the case of scheming to restrict the boot of the OS by utilizing this password check function, a user makes valid a password input request when booting the OS by the BIOS setup, and registers this password.

Then, when booting the OS next time after a shutdown of the OS, the user is requested to input the password before booting the OS. If the user does not input the password at this time, the OS can not be booted.

According to the conventional password check, once the password is set, the same password continues to be used unless the user voluntarily changes the password.

Accordingly, in the case of the user exhibiting a low frequency of changing the password, the same password remains unchanged in the great majority of cases. Further, the password is changed by utilizing the BIOS setup but can not be changed otherwise. Hence, the user unfamiliar with the BIOS setup comes to have a lower and lower frequency of changing the password.

Thus, a problem that the same password remains unchanged over a long period of time with the result that the security declines, is not limited to the OS boot password. For example, there arises a problem that a piece of authentication information for authenticating a user identity is not changed in an OS for authenticating the user identity and in a system where the user makes log-in to the OS. Moreover, the same problem occurs at a site for providing various categories of services on the Internet, wherein a fee-charged service is provided after authenticating the user identity.

Further, in order to avoid the situation given above, if a log-in password is not changed for a predetermined period of time when making the log-in to a system having a password-based authentication system, a technology of prompting the user to change the password, is carried out. This technology is not that the user is made to voluntarily change the password but that the system forces the user to change the password.

According to this technology, there is no necessity for the user to voluntarily start changing the password, and the password changing frequency becomes higher than the password check function based on the technology explained above, whereby the security can be enhanced.

According to this technology, however, the system forces the user to change the password regardless of a user's intention, resulting in a high possibility where the user might forget the password after being changed.

Further, if setting short a period for monitoring whether the password remains unchanged in order to enhance the security, the password is changed very often, and the user must, though the security is enhanced, figure out a new password frequently. According to this technology, the user has an increased burden and becomes hard to memorize the present password because of changing the password frequently.

Consequently, the user might fall into a situation of being unable to use the system because of the password being outside the user's memory. Moreover, if the user forgets the password, this involves an operation such as initializing the password, with the result that a system administrator comes to have a larger operation burden.

### SUMMARY OF THE INVENTION

It is a primary object of the present invention, which was devised to obviate the problems inherent in the prior art described above, to provide a technology capable of providing a function of offering more chances for changing a piece of authentication information.

It is another object of the present invention to provide a technology capable of providing a function of executing a process of setting the authentication information during an operation of a machine.

It is a further object of the present invention to provide a technology capable of increasing a frequency of changing the authentication information in a system for providing a service to a user after authenticating a user's identity.

To accomplish the above objects, according to one aspect of the present invention, a processing machine having an operating state and a stopping state, comprises a control unit (2, 8) making a request for inputting a predetermined piece of authentication information at a transition from the stopping state to the operating state, and restraining this transition if the authentication information is not inputted, and an authentication setting unit (2, 8) confirming a intention for executing a process of changing the authentication information when executing a predetermined process.

Preferably, the processing machine may further comprise a booting unit making a transition to the operating state from the stopping state, and the predetermined process maybe a transit process from the stopping state to the operating state by the booting unit (2, 8).

Preferably, the processing machine may further comprise a stopping unit (2, 8) making the processing machine transit to the stopping state from the operating state, and the predetermined process may be a transit process from the operating state to the stopping state by the stopping unit (2, 8).

Preferably, the stopping unit (2, 8) may execute a transit mode selected among a plurality of modes at the transition from the operating state to the stopping state, and a transit mode containing the process of confirming the intention for the execution may be one mode thereof.

Preferably, the authentication information may be character string information or biometric authentication information.

Preferably, the processing machine may further comprise a connecting unit (10) connecting an external device detachably, and the predetermined process may be a process of connecting or disconnecting the external device.

According to another aspect of the present invention, a processing machine including a connecting unit (10) connecting an external device detachably and having an operating state and a stopping state, comprises a control unit (2, 8) making a request for inputting a predetermined piece of authentication information at a transition from the stopping state to the operating state, and restraining this transition if the authentication information is not inputted, and an authentication setting unit (2, 8) making, when in a process of connecting or disconnecting the external device, a request for setting a new piece of authentication information.

According to another aspect of the present invention, an administration method of administering a processing machine having an operating state and a stopping state, comprises making a request for inputting a predetermined piece of authentication information at a transition from the stopping state to the operating state, and restraining this transition if the authentication information is not inputted (S4-S6), and confirming a intention for executing a process of changing the authentication information when executing a predetermined process (S12).

According to still another aspect of the present invention, a system having a providing state of providing a service to a user and a stopping state of sopping the service, comprises an authentication confirming unit (2) making a request for inputting a predetermined piece of authentication information at a transition from the service stopping state to the service providing state, and restraining this transition to the service providing state if the authentication information is not inputted, and an authentication setting unit (2) confirming a intention for executing a process of changing the authentication information when executing a predetermined process.

According to a further aspect of the present invention, an administration method of administering a system having a providing state of providing a service to a user and a stopping state of sopping the service, comprises making a request for inputting a predetermined piece of authentication information at a transition from the service stopping state to the service providing state, restraining this transition to the service providing state if the authentication information is not inputted, and confirming a intention for executing a process of changing the authentication information when executing a predetermined process (S33). Herein, the confirmation of the intention for executing the authentication information change process may involve judging that the change process is not executed if, for instance, a predetermined input is not given within a predetermined period of time.

According to a still further aspect of the present invention, there is provided a program executed by a machine to actualize any one of the above functions.

According to a yet further aspect of the present invention, there is provided a storage medium readable by a machine tangible embodying such a program.

As explained above, according to the present invention, it is feasible to offer more chances for the user to change the authentication information for restricting users of the machine, the system or the service, thereby making is possible to decrease a possibility of forgetting the authentication information after being changed even when a frequency of changing the authentication information increases.

Further, for example, the authentication information is changed when disconnecting an external device from the main body such as detaching an expansion station from the main body of the personal computer, and hence there is produced an effect of preventing a robbery of the main body and a resultant abuse of the machine.

### BRIEF DESCRIPTION OF THE DRAWINGS

FIG. 1 is a diagram showing a system architecture of a personal computer in a first embodiment of the present invention;

FIG. 2 is a flowchart showing a process starting with setting a password and ending with booting an OS;

FIG. 3 is a flowchart showing a process when shutting down the OS;

FIG. 4 is a flowchart showing a password change process;

FIG. 5 is a diagram showing an example of a present password input screen when booting and shutting down the OS;

FIG. 6 is a diagram showing an example of a new password input screen;

FIG. 7 is a diagram showing an example of a screen display when completing of update of the password;

FIG. 8 is a diagram showing an example of a screen display when failing to update the password;

FIG. 9 is a diagram showing an example of an OS shutdown menu;

FIG. 10 is a flowchart showing a process of changing a boot password when booting the OS;

FIG. 11 is a diagram showing an example of changing an OS log-in password when booting the OS in a second embodiment;

FIG. 12 is a diagram showing a system architecture of a personal computer in a third embodiment; and

FIG. 13 is a flowchart showing a process when disconnecting an expansion station.

### DETAILED DESCRIPTION OF THE PREFERRED EMBODIMENTS

Preferred embodiments of the present invention will hereinafter be described with reference to the accompanying drawings.

<<First Embodiment>>

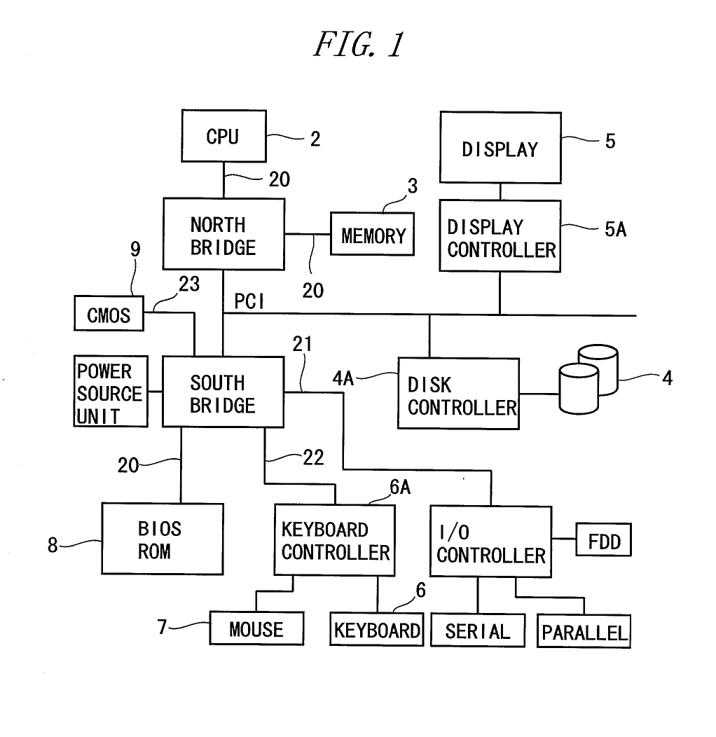

A first embodiment of the present invention will hereinafter be discussed referring to FIGS. 1 through 10.

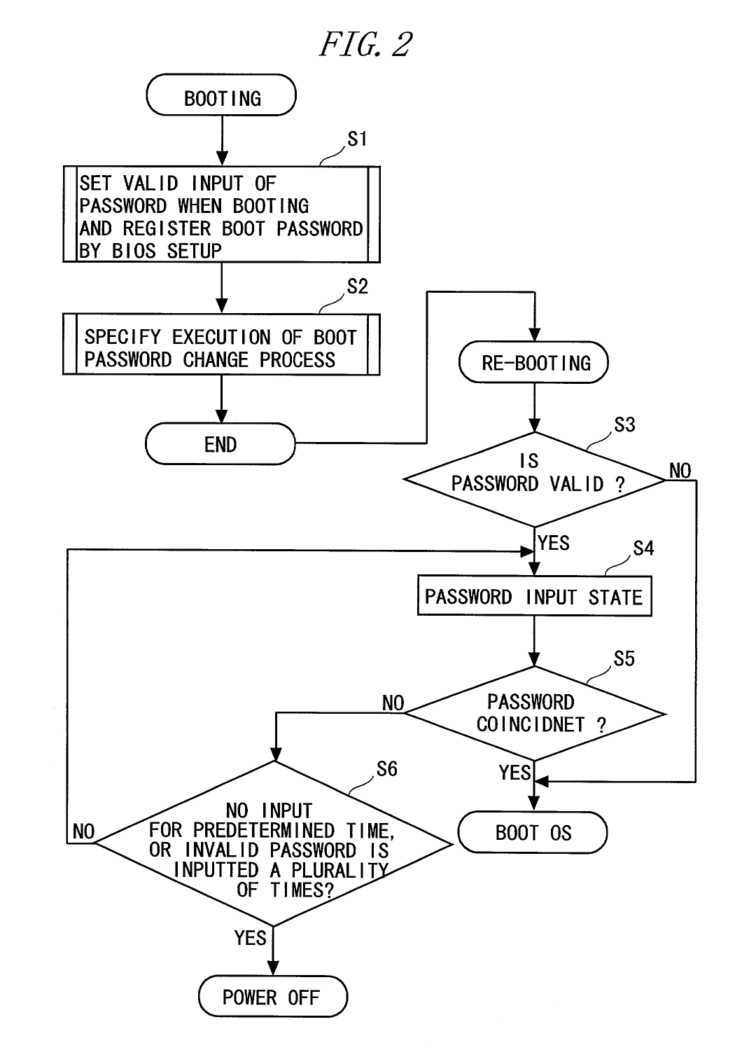

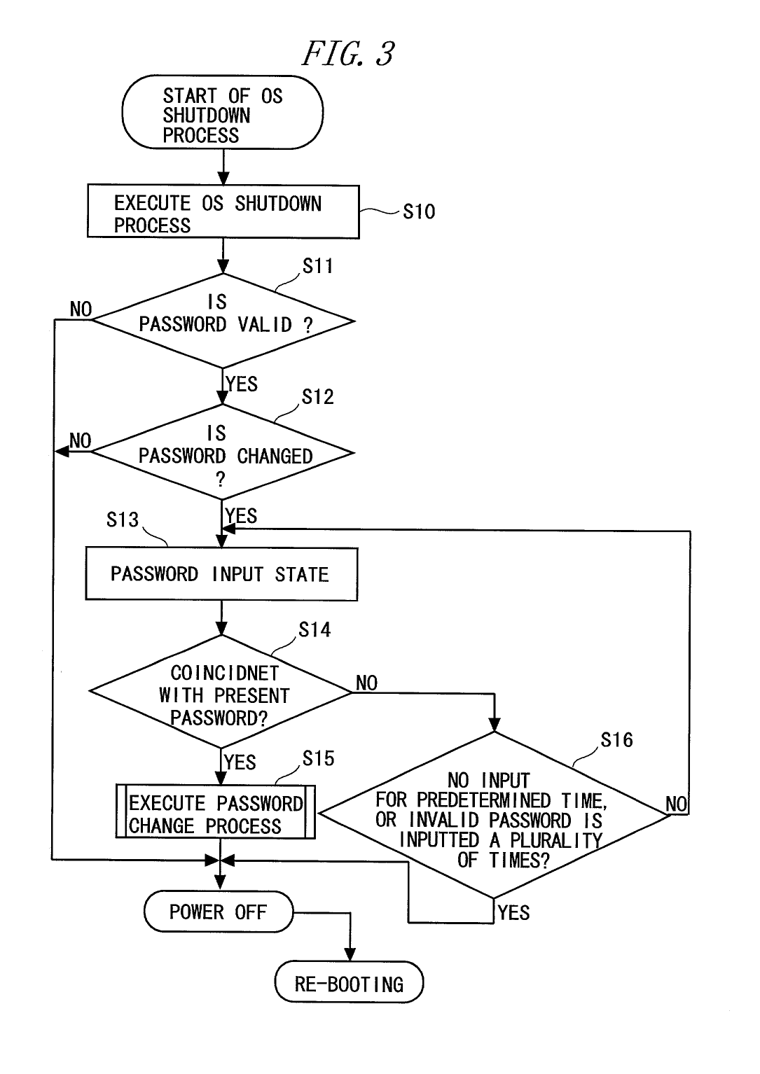

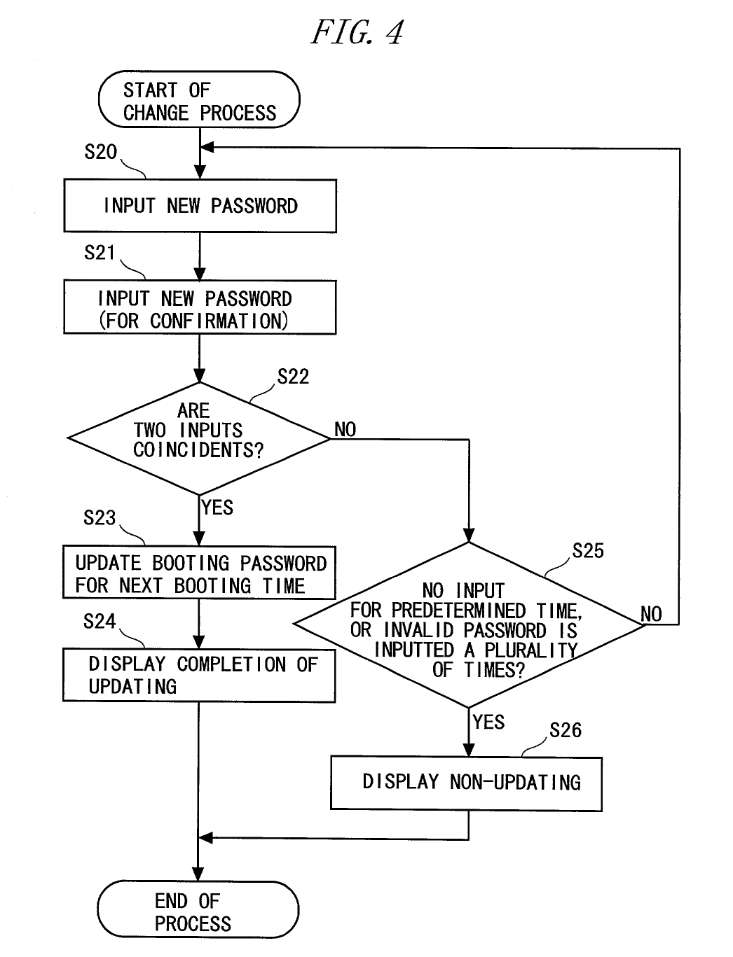

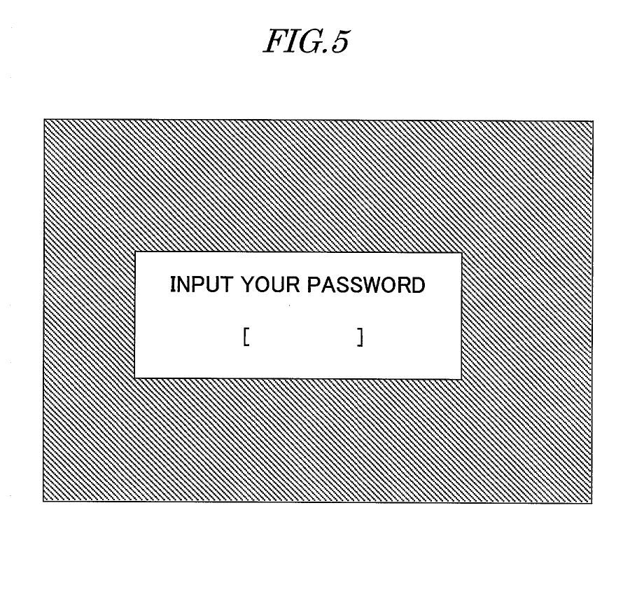

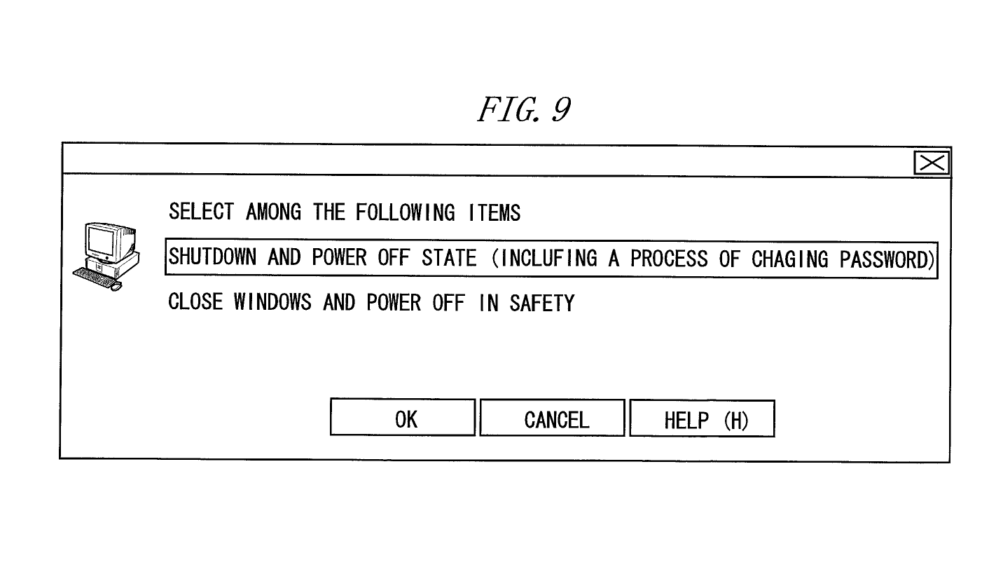

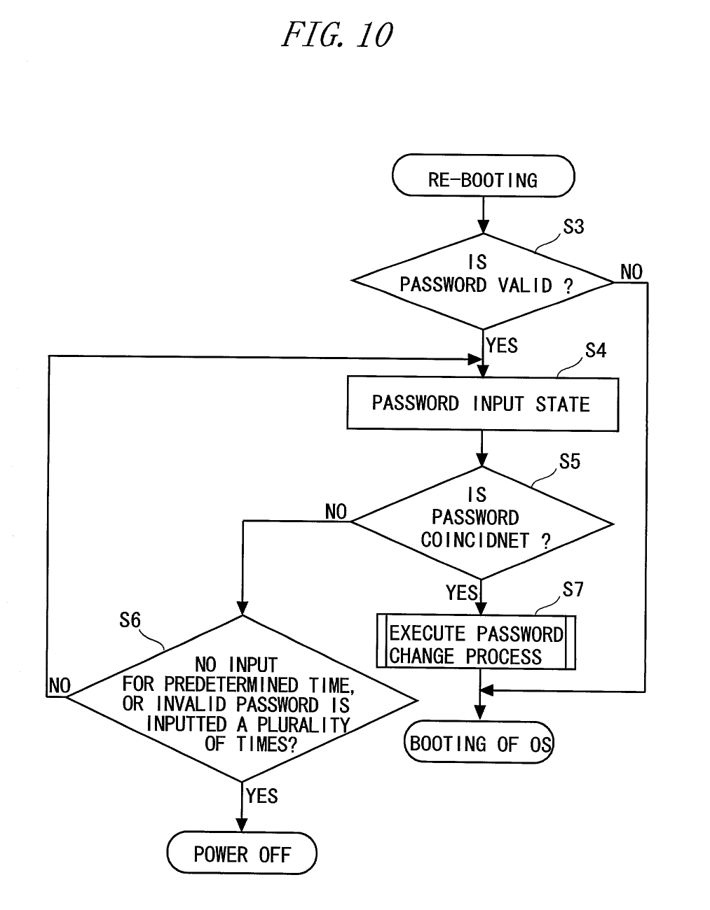

FIG. 1 is a diagram showing an architecture of a personal computer in the first embodiment. FIG. 2 is a flowchart showing a process starting with setting a password and ending with booting an OS, which is executed by a CPU 2 shown in FIG. 1. FIG. 3 is a flowchart showing a process when finishing the OS executed by the CPU 2. FIG. 4 is a flowchart showing a password changing process. FIGS. 5 through 8 show examples of a display screen on a display 5 shown in FIG. 1. FIG. 9 shows an example of an OS shutdown menu in a personal computer in the first embodiment. FIG. 10 is a flowchart showing an modified example (a process of changing a boot password when booting the OS) in the first embodiment.

<System Architecture>

FIG. 1 is the diagram showing the system architecture of the personal computer in the first embodiment.

This personal computer includes three units such as a north bridge, a south bridge and a power source unit. The north and south bridges are connected to each other via a PCI bus and cooperate with each other to provide a function of the personal computer.

The CPU 2 and a memory 3 are connected via an internal bus 20 to the north bridge. A disk controller 4A and a display controller 5A are connected via the PCI bus to the north bridge. Further, a hard disk 4 is connected to the disk controller 4A. Moreover, the display 5 is connected to the display controller 5A.

The CPU 2 executes a program developed on the memory 3, thereby providing a function of the personal computer. The memory 3 retains a program executed by the CPU 2 and data processed by the CPU 2.

The hard disk 4 is stored with executable image files of the program executed by the CPU 2, and with data files processed by the CPU 2.

The display 5 displays the data outputted from the CPU 2 and the data inputted by a user in accordance with a command given from the display controller 5A.

An input/output (I/O) unit in addition to the power source unit is connected via a high-speed I/O bus 21 to the south bridge. A floppy disk controller (FDD), a parallel interface, a serial interface etc are connected to this I/O unit. Further, the I/O unit is supplied electric power from power source unit.

Further, a keyboard controller 6A is connected via a serial bus 22 to the south bridge. Moreover, a keyboard 6 and a mouse 7 are connected to the keyboard controller 6A.

A ROM 8 stored with BIOS (Basic Input/Output System) is connected via an internal bus 20 to the south bridge. The BIOS controls devices, i.e., a variety of controllers such as the disk controller 4A, the display controller 5a, the I/O controller, the keyboard controller 6A. Further, the BIOS, when booting the OS, initializes these devices, and executes various settings.

Moreover, the BIOS, when the personal computer is powered on, tests the device in a POST (Power On Self Test) process whether the device can be normally started up in order to confirm that the device is normal, and thereafter executes booting the OS. Then, when booting the OS, the BIOS initializes these devices and executes the various settings.

Further, the BIOS, before booting the OS after the device has been powered on and the POST process has been completed, presents to a user a function of initializing a password (for booting the OS) for permitting the use of this machine.

This function is provided in the process that the BIOS executes the various settings (which will hereinafter be called a BIOS setup). Further, the password for restricting the boot of the OS is called a boot password (note that this boot password may also simply be referred to as a password).

Furthermore, a CMOS 9 is connected via an internal bus 23 to the south bridge. This CMOS 9 is a non-volatile memory always supplied with the power from a backup battery even in a state where the power supply of the personal computer is cut off. The COMS 9 is stored with piece of time data of a built-in timer of the personal computer and with the boot password etc when starting up the machines to which the present invention is related.

<Operation>

FIG. 2 is the flowchart showing the process starting with setting the boot password and ending with booting the OS, which is executed by the CPU 2 shown in FIG. 1.

As discussed above, it is required for validating the boot password that the BIOS setup be executed by the user. Namely, the setting of the boot password from a state where the boot password is not yet set involves, at first, the user's executing the BIOS setup.

Then, the user sets an at-the-boot password input request “valid”. Further, the user inputs the boot password that should be inputted in response to this input request. The BIOS registers the inputted “validating” indication and password in a predetermined area on the CMOS 9 (S1).

What is characteristic of the personal computer in the first embodiment is to make an inquiry about a request for changing the boot password during an OS shutdown process (which will hereinafter be called a boot password change process). The user, based on this BIOS setup, sets whether the boot password change process is executed or not (S2). Note that a piece of information on whether this password change process is executed or not, is also registered in a predetermined area on the CMOS 9.

Upon indicating a completion of the BIOS setup, the machine is restarted up, and the BIOS executes the POST process, and thereafter judges whether the boot password is valid or not (S3). If the boot password is invalid, the BIOS boots the OS as usual.

While on the other hand, if the boot password is valid, that is, when the boot password input request is set “valid” in S1, the BIOS requests the user to input the boot password (S4). FIG. 5 shows a screen displayed on the display 5 at this time. A state where this screen shown in FIG. 5 is displayed is called a password input state.

The user inputs the registered password onto this screen. The BIOS confirms this password inputted (S5). The BIOS, when confirming that the inputted password is correct (coincident), boots the OS.

While on the other hand, the BIOS, if unable to confirm that the password is correct (coincident), judges an input count in the password input state (S6). Then, if the password input count is equal to or smaller than a predetermined count, the BIOS sets the control again back to the password input state (S4).

If the judgement made in S6 is that the input count of the invalid password exceeds the predetermined count, the BIOS does not permit the OS to be booted and cuts off the power supply. Further, if the BIOS judges in S6 that nothing is inputted as the input state is kept for a predetermined period of time, the BIOS cuts off the power supply.

FIG. 3 is the flowchart showing the process when the OS is shut down, which is executed by the CPU 2. When the user selects an “end” from an OS shutdown menu, the CPU 2 executes the process shown in FIG. 3.

In this process, to start with, the CPU 2 executes a process required for shutting down the OS (S10). Upon a completion of the shutdown process executed on the OS side, the control is transferred to the BIOS. At first, the BIOS judges whether the boot password is “valid” (S11).

If the boot password is “valid”, the BIOS checks whether the BIOS setup is made to execute the password change process (S12). If the BIOS setup is not made to execute the password change process, the BIOS directly cuts off the power supply.

Whereas if the BIOS setup is made to execute the password change process, the BIOS requests the user to change the password. In this process, the BIOS, to begin with, prompts the user to input the present boot password in order to judge whether the password change should be permitted (S13). In this case, the screen to be displayed is the same as in FIG. 5.

Note that in the state where the OS is booted by inputting the valid boot password, a user identity is authenticated, and this state occurs, so that the process of inputting the present boot password may be omitted. Even in the state where the OS is booted by inputting the valid boot password, it is feasible to prevent a user other than the authorized user from trying to change the boot password by making the authorized user input the present boot password.

Next, the BIOS confirms the inputted password (S14-S16). A process if unable to confirm the correct password is the same as steps S4 through S6 in FIG. 2. If the correct password is inputted more than the predetermined count, or if nothing is inputted for the predetermined period of time, the BIOS skips over the password change process and cuts off the power supply.

Whereas if confirming that the correct boot password is inputted, the BIOS executes the password change process (S15). Thereafter, the BIOS cuts off the power supply.

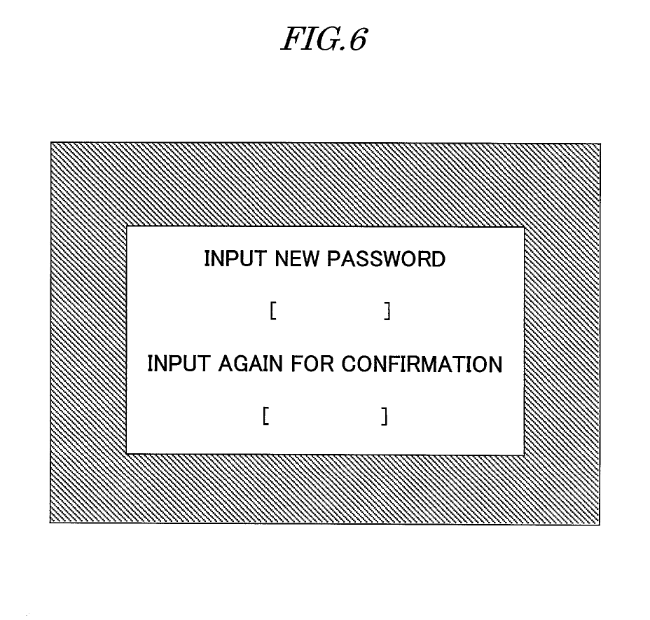

FIG. 4 shows details of the password change process. In this process, the BIOS at first requests the user to input a password that will be set afresh (S20). FIG. 6 shows an example of the screen displayed on the display 5 in this case.

When the new password is inputted once, the BIOS makes again the request for inputting the new password for its confirmation (S21). Next, the BIOS compares the passwords inputted twice with each other (S22).

Then, if the passwords inputted twice are coincident with each other, the BIOS updates this password into a boot password for the next time, and registers the updated password in a predetermined area on the CMOS 9 (S23). At this time, the old password is discarded.

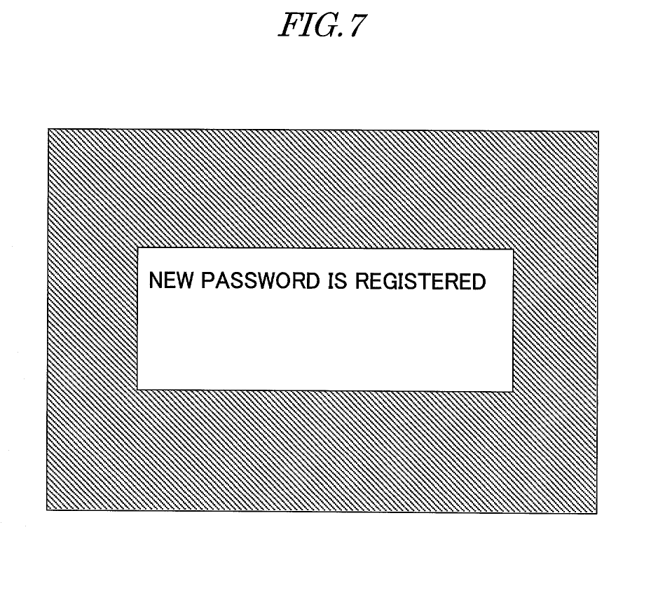

When the password is thus updated, the BIOS displays on the display 5 a message that the password has been updated as shown in FIG. 7 (S24).

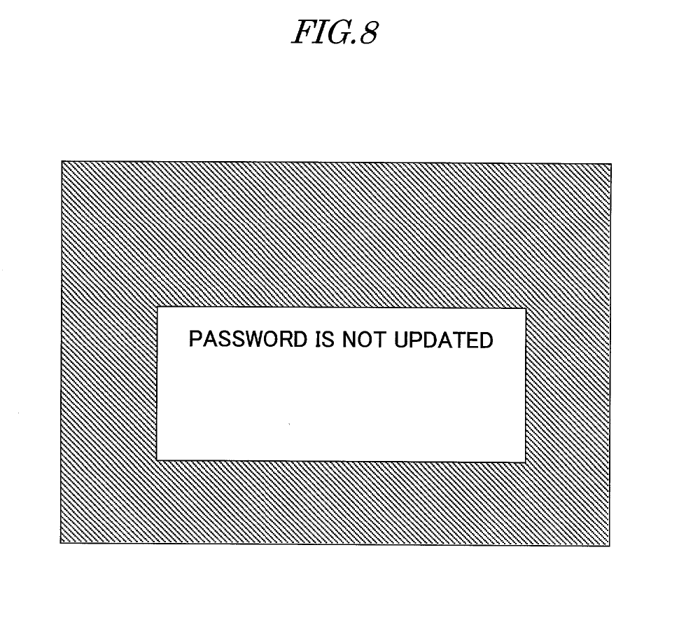

If the BIOS judges in S22 that the new passwords inputted twice are not coincident, the BIOS judges a new password input count (S25). Then, if the new password input count is equal to or smaller than the predetermined count, the BIOS sets the control again back to the new password input state (S20).

Whereas if the new password input count exceeds the predetermined count, the BIOS does not permit changing the boot password. Then, the BIOS displays on the display 5 a message that no password has been updated (S26). FIG. 8 shows the message displayed in this case.

Thereafter, the BIOS cuts off the power supply. Further, the BIOS, when judging in S25 that nothing is inputted as the input state is kept for the predetermined period of time, displays the message shown in FIG. 8 and cuts off the power supply.

Thus, according to the present invention in which the OS shutdown process contains the password change process, if judging that changing the password is required during the OS shutdown process, the user may change the password, and if judging that the change of the password is not required even when the password change request is given from the machine, the user may not change password.

Note that the boot password change process is executed during the OS shutdown process simply by performing the OS shutdown operation in the discussion given above, however, the OS shutdown process containing this boot password change process may also be implemented with the OS shutdown menu as one option of an OS shutdown mode as shown in FIG. 9. In the first embodiment discussed above, the boot password change process is executed each time the OS is shutdown, and by contrast the shutdown process is done as one option of the OS shutdown mode, whereby the user is able to easily change the password as the user intends.

As discussed above, the personal computer in the first embodiment is capable of providing the user with the chances of changing the boot password during the OS shutdown process by prompting the user to change the boot password when shutting down the OS on the basis of the BIOS setup and by displaying the OS shutdown menu containing the boot password change process as the option of the OS termination mode.

Therefore, the user has more chances of changing the boot password, and it is feasible to avoid the state where the boot password remains fixed over a long period of time, whereby the security can be improved. Further, the password is changed not by a forced process of the system but by the user's intention, and hence there is less possibility in which the user might forget the password after being changed. Moreover, the password change process is displayed to the user as one option of the OS shutdown mode when in the OS shutdown process which is indispensable for using the machine, and hence the password can be changed by the operation easy to the user unfamiliar with the BIOS setup operation.

<Modified Example>

The discussion in the first embodiment has focused on the personal computer making the request for changing the boot password when in the OS terminal process. Th embodiment of the present invention is not, however, limited to this procedure. For example, the request for changing the boot password may also be made when booting the OS.

FIG. 10 shows a process of changing the boot password when booting the OS. Referring to FIG. 10, steps S3 through S6 are the same as those when in the re-boot process shown in FIG. 2. Referring to FIG. 10, the BIOS, when confirming that the valid password is inputted, executes further the boot password change process (S7). The details of the boot password change process are the same as those in the flowchart shown in FIG. 4.

<<Second Embodiment>>

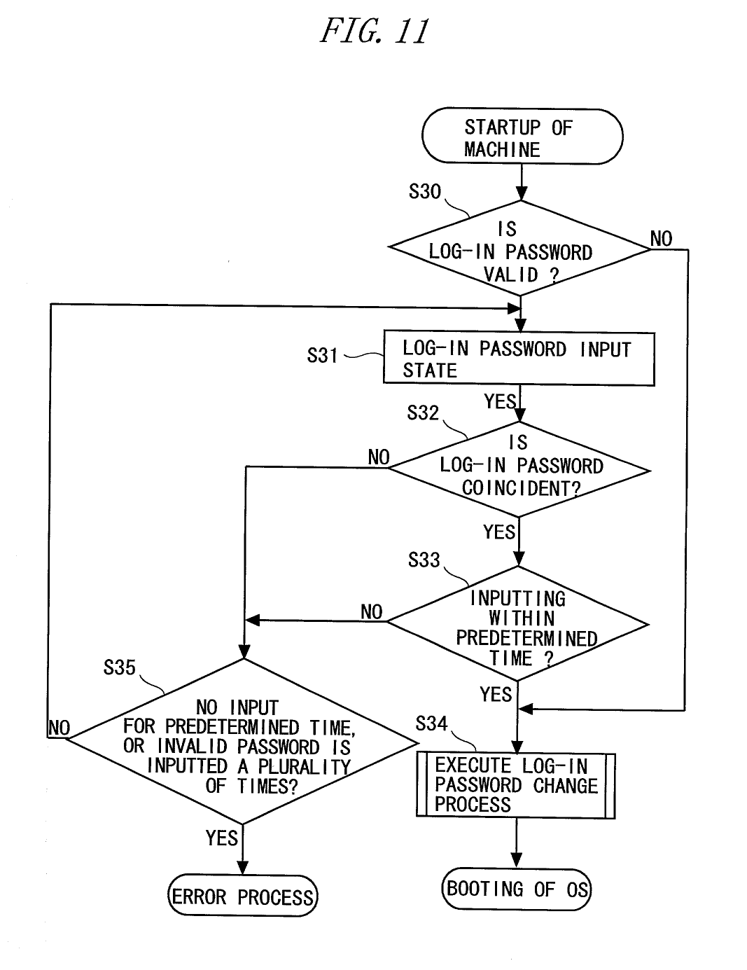

A second embodiment of the present invention will hereinafter be described with reference to FIG. 11. FIG. 11 is a flowchart showing an OS log-in password change process.

The first embodiment discussed above has exemplified the personal computer making the request for changing the boot password. On the other hand, the second embodiment will deal with a personal computer making a request for changing an OS log-in password when booting the OS. Other configurations and operations are the same as those in the first embodiment. Then, the same components are marked with the same numerals, and their repetitive explanations are omitted. Further, the drawings in FIGS. 1 through 10 are referred to according to the necessity.

FIG. 11 is a flowchart showing the OS log-in password change process executed by the personal computer (see FIG. 1) in the second embodiment. It is assumed that an OS log-in password is set beforehand when installing the OS or by a password setting utility.

When indicated to boot the OS, the OS at first judges whether the log-in password is “valid” (S30). It is confirmed whether the log-in password is set in the judgment.

If the log-in password is “valid”, the OS requests the user to input the log-in password (S31).

Next, the OS judges whether the correct (coincident) log-in password is inputted (S32). A process (S32, S34) if the correct log-in password is not inputted is the same as in the case (S14, S16 in FIG. 3) of the first embodiment.

On the other hand, in the judging process in S32, if the OS confirms the input of the correct password, the OS checks whether there is an input within a predetermined period of time (S33).

When judging in S33 that there is no input within the predetermined period of time, the OS is booted without changing the log-in password. If there is the input within the predetermined period of time, the log-in password change process is executed (S34). The log-in password change process is the same as the boot password change process (FIG. 4) in the first embodiment, however, the log-in password is stored not on the CMOS 9 but on the hard disk 4.

After the log-in password has been changed, the OS is booted as usual. When the user does log-in to the OS next time, the user inputs a new password as the log-in password.

Note that if there is the input within the predetermined period of time, it is judged in S33 that the user intends to change the log-in password. Whereas if not within the predetermined period of time, it is judged that the user does not intend to change the log-in password. This kind of process also makes it feasible to confirm that the user intends to execute the password change process.

As discussed above, the personal computer in the second embodiment, the log-in password is requested to be changed each time the OS is booted. It is therefore possible to prevent the log-in password from remaining unchanged over the long period of time.

In this case, if the user does not input the correct password and does not input within the predetermined time, it is judged that the user does not intend to change the log-in password. Accordingly, this password changing operation is not forced by the system but is executed under the user's intention as in the first embodiment.

<Modified Example>

The discussion in the second embodiment has been focused on the personal computer making the request for changing the log-in password when booting the OS. The embodiment of the present invention is not, however, confined to this procedure. For instance, when shutting down the OS, the PC may make the request for changing the OS log-in password.

Further, when performing the log-in to the OS or log-out from the OS, the PC may inquire of the user whether the log-in password is to be changed or not. Then, if specifying that the OS log-in password is changed, there may be executed the process of changing the OS log-in password.

Further, the embodiment of the present invention is not limited to changing the OS log-in password. For example, the present invention may be embodied for administering the password in a Web site for requesting the password and providing a service on the Internet. Thus, the present invention can be embodiment with respect to the general processes of authenticating the user identity with the password and so on.

<<Third Embodiment>>

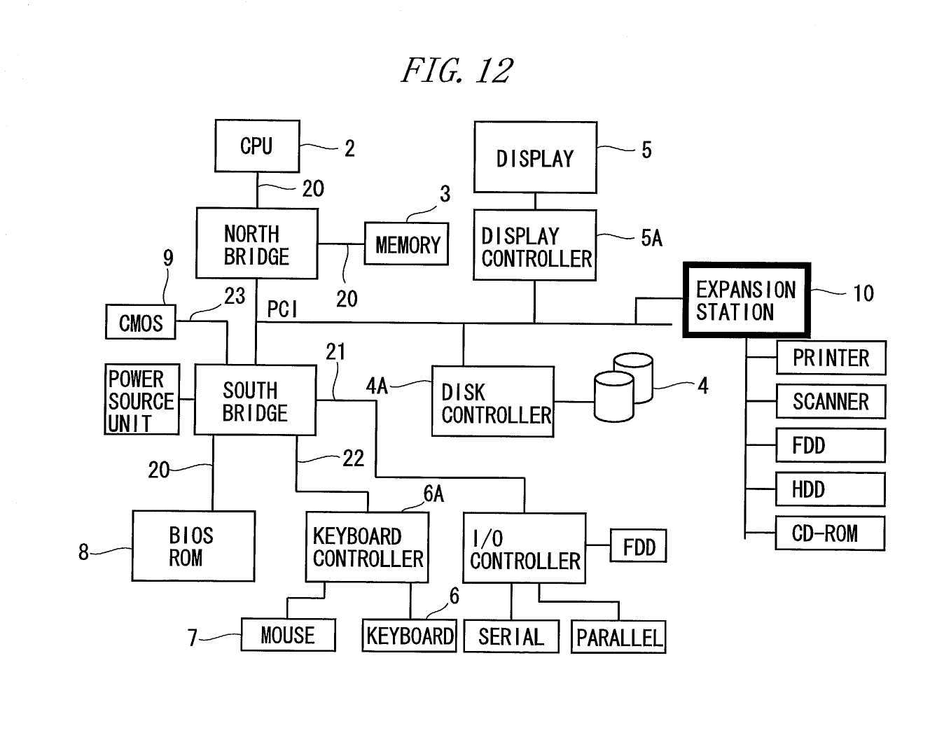

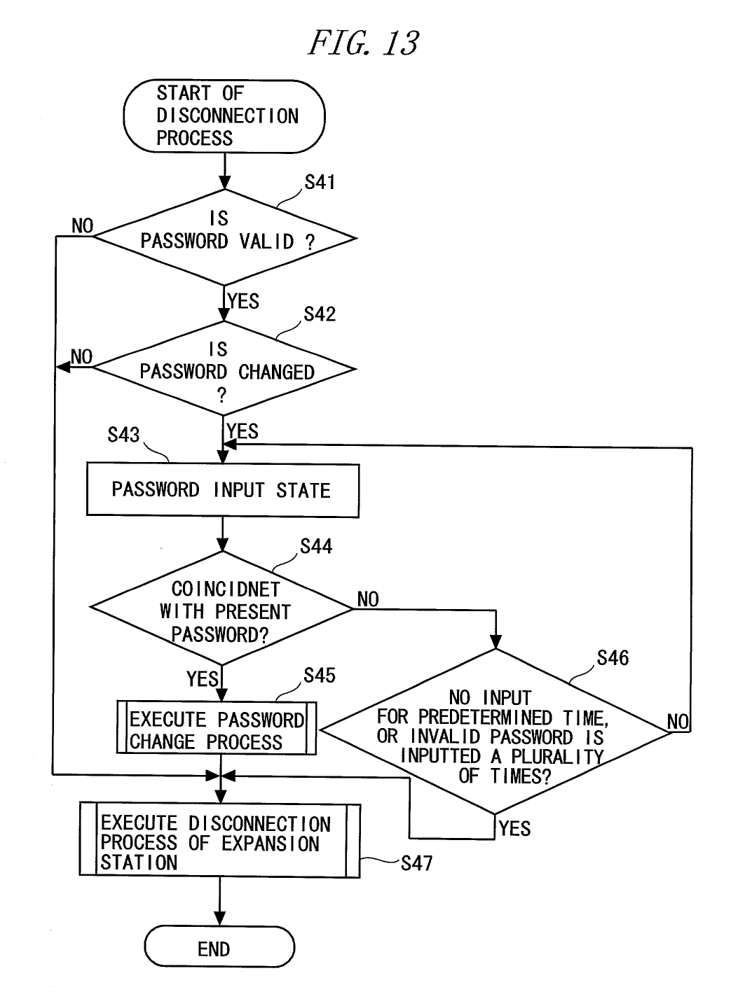

A third Embodiment of the present invention will be explained referring to FIGS. 12 and 13. FIG. 12 is a diagram showing a system architecture of the personal computer in the third embodiment. FIG. 13 is a flowchart showing a password change process executed by the CPU 2 shown in FIG. 12.

The first embodiment has exemplified the process of changing the boot password when shutting down the OS. On the other hand, the third embodiment will deal with a function of making the request for changing the boot password when disconnecting an external device, e.g., an expansion station from the personal computer. Other configurations and operations are the same as those in the first embodiment. Then, the same components are marked with the same numerals, and their repetitive explanations are omitted.

FIG. 12 is the diagram showing the system architecture of the personal computer in the third embodiment. The personal computer in FIG. 12 is different from the personal computer in the first embodiment (FIG. 1) in terms of such a point that an expansion station 10 (and peripheral devices connected to the expansion station 10) are connected to the personal computer.

Herein, the expansion station 10 is defined as a device including a plurality of expansion-oriented interfaces for connecting the peripheral devices such as a printer, a scanner, a hard disk drive, a floppy disk drive, a CD-ROM drive to the personal computer. An expandability of the personal computer can be improved by adding the expansion station 10 to the personal computer.

For instance, in the case of adding, to a notebook type personal computer, functions (of the floppy disk drive and the CD-ROM drive) not incorporated into the main body thereof, the expansion station 10 is utilized. In this case, to begin with, the peripheral devices are connected to the expansion station 10, and then this expansion station 10 is connected to the main body of the personal computer.

Generally, when using the notebook PC indoors, the user utilizes it in a way that attaches the expansion station 10 to the main body thereof. On the other hand, if the user brings the notebook PC outdoors and uses it there, in the great majority of cases the user detaches the expansion station 10 therefrom and brings only the main body out.

The personal computer in the third embodiment execute a process of prompting the user to change the password in an OS process when detaching the expansion station 10 (which will hereinafter be called a disconnection process). In the personal computer in the third embodiment, the password setting process of the first time is the same as that in the first embodiment (FIG. 2).

FIG. 13 is a flowchart showing the disconnection process of the expansion station 10, which is executed by the OS. This disconnection process is executed when the user manipulates the keyboard 6 or the mouse 7 to request the personal computer to detach the expansion station.

The OS, when receiving the request from the user, executes the process shown in FIG. 13. Referring to FIG. 13, steps S41 through S46 are the same as steps S11 to S16 shown in FIG. 3 in the first embodiment. Namely, the OS prompts the user to input the boot password (S43), and, after confirming that the correct (coincident) boot password has been inputted (S44), executes the boot password change process (S45). Thereafter, the OS executes the disconnection process of the expansion station 10.

Note that if the expansion station 10 is detached in a state where the power supply is cut off, the OS is made to confirm that the expansion station 10 is disconnected during the next booting process and made to execute the process of requesting the user to change the boot password.

As discussed above, according to the personal computer in the third embodiment, in the disconnection process of the expansion station 10, the user is requested to change the boot password. It is therefore feasible to increase a frequency of changing the boot password.

Further, when detaching the expansion station from the main body of the personal computer, the password is changed, and hence there is exhibited an effect of preventing a robbery and a resultant abuse of the personal computer by detaching the expansion station from the main body thereof.

<Modified Example>

The personal computer in the third embodiment discussed above requests the user to change the boot password during the disconnection process of the expansion station 10. The embodiment of the present-invention is not, however, confined to this procedure.

For instance, in an OS process of connecting the expansion station 10 to the personal computer (which will hereinafter be called an establishment of connecting the expansion station 10), the user may be requested to change the boot password.

Moreover, the embodiment of the present invention is limited to neither the establishment of the connection nor the disconnection of the expansion station 10. For example, when connecting a new piece of peripheral device to the personal computer, the user may be requested to change the boot password.

Further, in the case of setting resources of the personal computer such as a size of a virtual memory area, a window size of a real memory and so on, the user may be requested to change the boot password.

The embodiment discussed above has exemplified the personal computer requesting the user to change the boot password when in the predetermined process, e.g., when shutting down the OS. The embodiment of the present invention is not, however, restricted to the architecture and operation described above.

For example, the present invention can be embodied in the general machines each having the operating state and the stopping state in place of the personal computer described above. The present invention can be embodiment in, e.g., a server, a PDA (Personal Digital Assistant), a mobile telephone etc that request a password when starting up the system after the system has been powered on.

According to the personal computer in the embodiment discussed above, the security management is done based on the password. The embodiment of the present invention is not, however, limited to this mode. As substitutes for the password, for example, the security management may be implemented by so-called biometric authentication such as authenticating the user identity with a fingerprint, a voice and a pattern of the retina or iris. For attaining this, when booting and terminating the OS, and when connecting or disconnecting the external device, these pieces of biometric authentication information may be registered.

<<Storage Medium Readable by a Machine>>

The program for actualizing any one of the functions exemplified in the embodiments discussed above may be recorded on a storage medium readable by a machine. Then, the machine reads and executes the program on this recording medium, thereby functioning as personal computer or the system shown in the embodiments discussed above.

Herein, the storage medium readable by a machine embraces recording mediums capable of storing information such as data, programs, etc. electrically, magnetically, optically and mechanically or by chemical action, which can be all read by the computer. What is demountable out of the computer among those recording mediums may be, e.g., a floppy disk, a magneto-optic disk, a CD-ROM, a CD-R/W, a DVD, a DAT, an 8 mm tape, a memory card, etc..

Further, a hard disk, a ROM (Read Only Memory) and so on are classified as fixed type recording mediums within the computer.

<Data Communication Signal Embodied in Carrier Wave>

Furthermore, the above program may be stored in the hard disk and the memory of the computer, and downloaded to other computers via communication media. In this case, the program is transmitted as data communication signals embodied in carrier waves via the communication media. Then, the computer downloaded with this program can be made to function as the personal computer or the system in the embodiments discussed above.

Herein, the communication media may be any one of cable communication mediums such as metallic cables including a coaxial cable and a twisted pair cable, optical communication cables, or wireless communication media such as satellite communications, ground wave wireless communications, etc.

Further, the carrier waves are electromagnetic waves for modulating the data communication signals, or the light. The carrier waves may, however, be DC signals. In this case, the data communication signal takes a base band waveform with no carrier wave. Accordingly, the data communication signal embodied in the carrier wave may be any one of a modulated broadband signal and an unmodulated base band signal (corresponding to a case of setting a DC signal having a voltage of 0 as a carrier wave).

What is claimed is:

1. A processing machine having an operating state and a stopping state, comprising:
a control unit making a request for inputting a predetermined piece of authentication information at a transition from the stopping state to the operating state, and restraining this transition if the authentication information is not inputted; and
an authentication setting unit confirming an intention for executing a process of changing the authentication information when executing a predetermined process.

2. A processing machine according to claim 1, further comprising a booting unit making a transition to the operating state from the stopping state,
wherein the predetermined process is a transit process from the stopping state to the operating state by said booting unit.

3. A processing machine according to claim 1, further comprising a stopping unit making said processing machine transit to the stopping state from the operating state,
wherein the predetermined process is a transit process from the operating state to the stopping state by said stopping unit.

4. A processing machine according to claim 3, wherein said stopping unit executes a transit mode selected among a plurality of modes at the transition from the operating state to the stopping state, and
a transit mode containing the process of confirming the intention for the execution is one mode thereof.

5. A processing machine according to claim 1, wherein the authentication information is character string information or biometric authentication information.

6. A processing machine according to claim 1, further comprising a connecting unit connecting an external device detachably,
wherein the predetermined process is a process of connecting or disconnecting said external device.

7. A processing machine including a connecting unit connecting an external device detachably and having an operating state and a stopping state, comprising:
a control unit making a request for inputting a predetermined piece of authentication information at a transition from the stopping state to the operating state, and restraining this transition if the authentication information is not inputted; and
an authentication setting unit making, when in a process of connecting or disconnecting said external device, a request for setting a new piece of authentication information.

8. An administration method of administering a processing machine having an operating state and a stopping state, comprising:
making a request for inputting a predetermined piece of authentication information at a transition from the stopping state to the operating state, and restraining this transition if the authentication information is not inputted; and
confirming an intention for executing a process of changing the authentication information when executing a predetermined process.

9. An administration method according to claim 8, wherein the predetermined process is a transit process from the stopping state to the operating state in said processing machine.

10. An administration method according to claim 8, wherein the predetermined process is a transit process from the operating state to the stopping state in said processing machine.

11. An administration method according to claim 11, further comprising executing a transit mode selected among a plurality of modes at the transition from the operating state to the stopping state,
wherein the plurality of modes include, as one mode, a transit mode containing the process of confirming the intention for the execution.

12. An administration method according to claim 8, wherein the authentication information is character string information or biometric authentication information.

13. An administration method according to claim 8, further comprising, said processing machine including a connecting unit connecting an external device detachably, establishing a connection with said external device,
wherein the establishment of the connection involves confirming an intention for executing the process of changing the authentication information.

14. An administration method according to claim 8, further comprising, said processing machine including a connecting unit connecting an external device detachably, disconnecting the said external device,
wherein the disconnecting involves confirming the intention for executing the process of changing the authentication information.

15. An administration method of administering a processing machine including a connecting unit connecting an external device detachably, comprising:
making a request for inputting a predetermined piece of authentication information at a transition from a stopping state to an operating state, and restraining this transition if the authentication information is not inputted; and
making, when in a process of connecting or disconnecting said external device, a request for setting a new piece of authentication information.

16. A storage medium readable by a machine tangible embodying a program of instructions executable by the machine to perform method steps comprising:
making a request for inputting a predetermined piece of authentication information at a transition from the stopping state to the operating state, and restraining this transition if the authentication information is not inputted; and
confirming an intention for executing a process of changing the authentication information when executing a predetermined process.

17. A storage medium readable by a machine tangible embodying a program according to claim 16, the method steps further comprising booting said machine,
wherein the predetermined process is a transit process from the stopping state to the operating state in booting said machine.

18. A storage medium readable by a machine tangible embodying a program according to claim 16, the method steps further comprising stopping said machine,
wherein the predetermined process is a transit process from the operating state to the stopping state in stopping said machine.

19. A storage medium readable by a machine tangible embodying a program according to claim 18, wherein stopping said machine involves executing a transit mode selected among a plurality of modes at the transition from the operating state to the stopping state, and
the plurality of modes include, as one mode, a transit mode containing the process of confirming the intention for the execution.

20. A storage medium readable by a machine tangible embodying a program according to claim 16, wherein the authentication information is character string information or biometric authentication information.

21. A storage medium readable by a machine tangible embodying a program according to claim 16, the method steps further comprising, said machine including a connecting unit connecting an external device detachably, establishing a connection with said external device,
wherein the establishment of the connection involves confirming an intention for executing the process of changing the authentication information.

22. A storage medium readable by a machine tangible embodying a program according to claim 16, the method steps further comprising, said machine including a connecting unit connecting an external device detachably, disconnecting said external device,
wherein the disconnecting involves confirming the intention for executing the process of changing the authentication information.

23. A storage medium readable by a machine tangible embodying a program of instructions executable by the machine to perform method steps comprising:
making a request for inputting a predetermined piece of authentication information at a transition from a stopping state to an operating state, and restraining this transition if the authentication information is not inputted; and
making, when in a process of connecting or disconnecting said external device, a request for setting a new piece of authentication information.

24. A system having a providing state of providing a service to a user and a stopping state of sopping the service, comprising:
an authentication confirming unit making a request for inputting a predetermined piece of authentication information at a transition from the service stopping state to the service providing state, and restraining this transition to the service providing state if the authentication information is not inputted; and
an authentication setting unit confirming an intention for executing a process of changing the authentication information when executing a predetermined process.

25. An administration method of administering a system having a providing state of providing a service to a user and a stopping state of sopping the service, comprising:
making a request for inputting a predetermined piece of authentication information at a transition from the service stopping state to the service providing state, and restraining this transition to the service providing state if the authentication information is not inputted; and
confirming an intention for executing a process of changing the authentication information when executing a predetermined process.

26. A storage medium readable by a machine tangible embodying a program of instructions executable by the machine having a providing state of providing a service to a user and a stopping state of sopping the service, comprising:
confirming unit making a request for inputting a predetermined piece of authentication information at a transition from the service stopping state to the service providing state, and restraining this transition to the service providing state if the authentication information is not inputted; and
confirming an intention for executing a process of changing the authentication information when executing a predetermined process.
